(19) United States
(12) Patent Application Publication
(10) Pub. No.: US 2005/0264726 A1
(43) Pub. Date: Dec. 1, 2005

(54) Polarizing plate

(75) Inventors: Yoshiteru Ohta, Narashino-shi (JP); Narutoshi Hayashi, Niihama-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Sumitomo Chemical Company, Limited

(21) Appl. No.: 11/137,097

(22) Filed: May 25, 2005

(30) Foreign Application Priority Data
May 26, 2004 (JP) 2004-155792

(51) Int. Cl. G02F 1/1335

(52) U.S. Cl. 349/113

(57) ABSTRACT

[1] A polarizing plate comprising a dye and a hindered amine-based compound. [2] The polarizing plate according to [1], wherein the polarizing plate comprises a dye-based polarizing film and a protective film pasted via an adhesive for polarizing plate containing a hindered amine-based compound and at least one adhesive component selected from the group consisting of an adhesive component containing a polyvinyl alcohol having a molecular weight of 20,000 to 200,000 as an active ingredient, an adhesive component containing an acrylic resin as an active ingredient and an adhesive component containing a urethane resin as an active ingredient.

### TECHNICAL FIELD OF THE INVENTION

The present invention relates to a polarizing plate.

### BACKGROUND OF THE INVENTION

Flat panel displays (FPD) such as liquid crystal displays (LCD), organic electroluminescence (EL) and the like are used in liquid crystal projectors, vehicle applications and the like In FPD, a polarizing plate is used, and in this polarizing plate, a polarizing film produced by allowing iodine or dichroic dye as a polarizing material to be contained in a polarizing film base material such as a film made of a polyvinyl alcohol or its derivative stretched-oriented and the like, a polarizing film in which a polyene is produced and oriented by dehydrochlorination of a polyvinyl chloride film or dehydration of a polyvinyl alcohol-based film, and the like are used.

It is known that a dye-based polarizing film using a dichroic dye as a polarizing material generally has more excellent light resistance and the like under high temperature and high humidity conditions as compared with an iodine-based polarizing film (see, Japanese Patent Application Laid-Open (JP-A) No. 2001-240762 ([0065] Effect of the Invention)).

A polarizing plate obtained by pasting a protective film on a dye-based polarizing film having such a property is generally used in liquid crystal projectors and vehicle applications due to excellent light resistance. Recently, since FPD is required to be used outdoors and light quantity increases, there is a demand for a polarizing plate manifesting further higher light resistance.

### DISCLOSURE OF THE INVENTION

An object of the present invention is to provide a polarizing plate manifesting higher light resistance.

The present inventors have studied to find a polarizing plate manifesting further higher light resistance and resultantly found that a polarizing plate containing a dye and a hindered amine-based compound shows further higher light resistance.

Namely, the present invention provides the following [1] to [6].

[1] A polarizing plate comprising a dye and a hindered amine-based compound.

[2] The polarizing plate according to [1], wherein the polarizing plate comprises a dye-based polarizing film and a protective film pasted via an adhesive for polarizing plate containing a hindered amine-based compound and at least one adhesive component selected from the group consisting of an adhesive component containing a polyvinyl alcohol having a molecular weight of 20,000 to 200,000 as an active ingredient, an adhesive component containing an acrylic resin as an active ingredient and an adhesive component containing a urethane resin as an active ingredient.

[3] The polarizing plate according to [1] or [2], wherein the hindered amine-based compound is a compound having a 2,2,6,6-tetramethylpiperidine skeleton.

[4] The polarizing plate according to any one of [1] to [3], wherein the polarizing film is a film made of a polyvinyl alcohol-based resin.

[5] A flat panel display comprising the polarizing plate according to any one of [1] to [4].

[6]. An adhesive for polarizing plate comprising a hindered amine-based compound and at least one adhesive component selected from the group consisting of an adhesive component containing a polyvinyl alcohol having a molecular weight of 20,000 to 200,000 as an active ingredient, an adhesive component containing an acrylic resin as an active ingredient and an adhesive component containing a urethane resin as an active ingredient.

The present invention will be illustrated in detail below.

The polarizing plate of the present invention is a polarizing plate containing a dye and a hindered amine-based compound, and specifically listed
(a) a polarizing plate obtained by allowing a hindered amine-based compound to be contained in a resin for polymer film such as a polyvinyl alcohol and the like by a method such as mixing, melt kneading and the like, then, forming a film from the resin, allowing a dichroic dye to be contained in the resulted film (polarizing film base plate) to obtain a dye-based polarizing film, subsequently, pasting a protective film on the polarizing film,
(b) a polarizing plate obtained by allowing a dichroic dye and a hindered amine-based compound to be contained in a film (polarizing film base material) made of a resin for polymer film by a method such as immersion and the like to obtain a dye-based polarizing film, subsequently, pasting a protective film on the polarizing film,
(c) a polarizing plate obtained by allowing a dichroic dye to be contained in a film (polarizing film base material) made of a resin for polymer film to obtain a dye-based polarizing film, separately, preparing an adhesive for polarizing plate containing a hindered amine-based compound and a polyvinyl alcohol having lower molecular weight, and pasting a protective film via the adhesive on the polarizing film,
   and the like.

Among them, the polarizing plate (c) is preferable since conventional dye-based polarizing films and protective films can be used as they are.

The polarizing plate (c) as a polarizing plate containing a dye and a hindered amine-based compound will be described below.

The polarizing plate of the present invention can be produced by, for example, allowing a dichroic dye to be contained in a polarizing film base material as a polymer film to give a polarizing film, further, pasting a protective film excellent in optical transparency and mechanical strength on one surface or both surfaces of this polarizing film using an adhesive containing a hindered amine-based compound.

Mentioned as the polarizing film base material are polymer films made of, for example, a polyvinyl alcohol-based resin, polyvinyl acetate resin, ethylene/vinyl acetate (EVA) resin, nylon resin, polyester resin or the like.

Here, the polyvinyl alcohol-based resin includes, polyvinyl alcohol itself as a partially or completely saponified substance of polyvinyl acetate, also saponified substances of copolymers of vinyl acetate with other copolymerizable monomers such as saponified EVA resins, polyvinyl formal and polyvinyl acetyl obtained by modifying polyvinyl alcohol with aldehydes, and the like. Here, the other copolymerizable monomer includes olefins such as ethylene and propylene, unsaturated carboxylic acids such as crotonic acid, acrylic acid, methacrylic acid and maleic acid, unsaturated sulfonic acids, vinyl ethers and the like.

As the polarizing film base material, there are suitably used polyvinyl alcohol-based films, particularly, polyvinyl alcohol films from the standpoint of adsorption property and orientation property of a dye.

In allowing a dichroic dye to be contained in a polarizing film base material, usually adopted is a method of dyeing a polarizing film base material. Orientation of a dye is conducted by stretching a polarizing film base material. As the stretching method, for example, any methods such as wet methods, dry methods and the like may be adopted. Stretching of a polarizing film base material may be effected before dyeing or after dyeing.

A dye-based polarizing film in which a dichroic dye is contained and oriented may be used as it is, and it is preferable to perform a post treatment such as treatment with boric acid, and the like. Such a post treatment is conducted usually for the purpose of improving the beam transmittance, degree of polarizing and durability of a polarizing film.

On thus obtained dye-based polarizing film, a protective film excellent in optical transparency and mechanical strength can be pasted on its one surface or both surfaces, to give a polarizing plate.

Examples of materials forming a protective film include triacetylcellulose-based films, acrylic films, fluorine resin-based films such as ethylene tetrafluoride/propylene hexafluoride copolymers, polyester-based films, polyolefin-based films, polyamide-based films and the like. Of them, triacetylcellulose-based films are preferably used.

A dye-based polarizing film and a protective film are pasted via an adhesive.

This adhesive is an adhesive for polarizing plate comprising a hindered amine-based compound and at least one adhesive component selected from the group consisting of an adhesive component containing a polyvinyl alcohol having a molecular weight of 20,000 to 200,000 as an active ingredient, an adhesive component containing an acrylic resin as an active ingredient and an adhesive component containing a urethane resin as an active ingredient. As the adhesive component, commercially available adhesives which are transparent and having optical anisotropy may be used as they are.

Of them, the adhesive component containing a polyvinyl alcohol having a molecular weight of 20,000 to 200,000 as an active ingredient is suitable due to excellent adhesion.

Examples of the adhesive component containing a polyvinyl alcohol as an active ingredient include “Kuraray Poval (trade name)” PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-228, PVA-235, PVA-217EE, PVA-217, PVA-220E, PVA-224E, PVA-403, PVA-405, PVA-420, PVA-613, KL-506, KL-318, KL-118, KM-618, KM-118, C-506, R-1130 and the like manufactured by Kuraray Co. Ltd., “Gohsenol (trade name)” NH-26, NH-20, NH-18, NM-14, AH-26, AH-22, AH-17, GH-23, GM-14, GL-05, KH-17, KP-08 and the like manufactured by Nippon Synthetic Chemical Industry Co. Ltd., “Gohsefimer (trade name)” Z-100, Z-200, Z-210, Z-200H and the like manufactured by Nippon Synthetic Chemical Industry Co. Ltd., and the like.

The adhesive may contain a surfactant and the like within a range not deteriorating optical properties, adhesion and durability.

The hindered amine-based compound is secondary amine or tertiary amine in which a methyl group is substituted on a carbon adjacent to an amino group to sterically protecting the amino group, and specifically mentioned are compounds having a 2,2,6,6-tetramethylpiperidine skeleton of the following 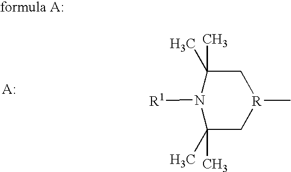
wherein, R¹ represents a hydrogen atom, oxy radical, alkyl group having 1 to 16 carbon atoms, alkoxy group having 1 to 16 carbon atoms or acyl group having 1 to 16 carbon atoms.

Examples of the alkyl group having 1 to 16 carbon atoms include a methyl group, ethyl group, n-propyl group, iso-propyl group, n-butyl group, sec-butyl group, tert-butyl group, n-hexyl group, n-pentyl group, n-octyl group, nonyl group, decyl group, undecyl group, dodecyl group, tridecyl group, tetradodecyl group, pentadecyl group, hexadecyl group, heptadecyl group, octadecyl group and the like.

Examples of the alkoxy group having 1 to 16 carbon atoms include a methoxy group, ethoxy group, n-propoxy group, iso-propoxy group, n-butoxy group, sec-butoxy group, tert-butoxy group, n-hexyloxy group, n-pentyloxy group, n-octyloxy group, nonyloxy group, decyloxy group, undecyloxy group, dodecyloxy group, tridecyloxy group, tetradodecyloxy group, pentadecyloxy group, hexadecyloxy group, heptadecyloxy group, octadecyloxy group and the like.

Examples of the acyl group having 1 to 16 carbon atoms include a formyl group, acetyl group, n-propionyl group, iso-propilonyl group, n-butyryl group, sec-butyryl group, tert-butyryl group, n-valeryl group, n-hexanoyl group, n-pentanoyl group, n-octanoyl group, nonanoyl group, decanoyl group, undecanoyl group, dodecanoyl group, tridecanoyl group, tetradecanoyl group, pentadecanoyl group, hexadecanoyl group, heptadecanoyl group and the like.

As the hindered amine-based compound having one “A” in the molecule, for example, the following compounds (1) to (7) are mentioned. 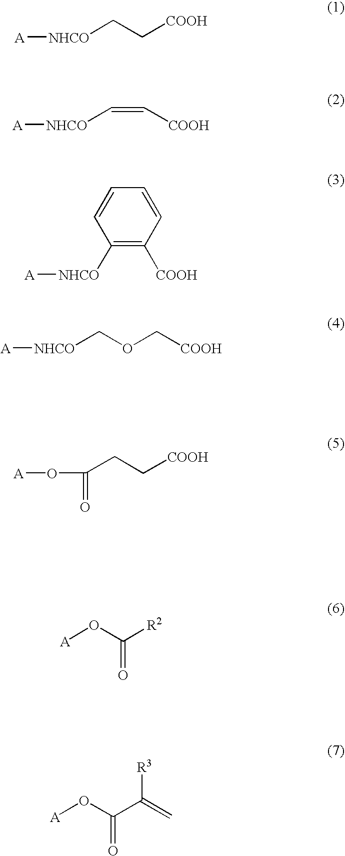
wherein, A represents the same meaning as described above. R² represents an alkyl group having 8 to 20 carbon atoms and R³ represents a hydrogen atom or methyl group.

Examples of the alkyl group having 8 to 20 carbon atoms include a n-octyl group, nonyl group, decylgroup, undecylgroup, dodecyl group, tridecyl group, tetradodecyl group, pentadecyl group, hexadecyl group, heptadecyl group, octadecyl group and the like.

As the hindered amine-based compound containing two ‘A’s in the molecule, the following compounds (8) to (10) are mentioned. 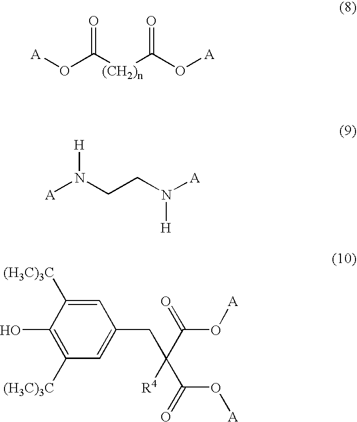
wherein, A has the same meaning as described above, and A may be mutually different. n represents 2 to 20, preferably 6 to 10. R⁴ represents a hydrogen atom or alkyl group having 1 to 8 carbon atoms.

Examples of the alkyl group having 1 to 8 carbon atoms include a methyl group, ethyl group, n-propyl group, iso-propyl group, n-butyl group, sec-butyl group, tert-butyl group, n-hexyl group, n-pentyl group, n-octyl group and the like.

As the hindered amine-based compound having ‘A’ in the molecule, the following compound (II) and the like are mentioned.
H₃C—COO—R⁵
H [symbol] —COO—R⁵
H [symbol] —COO—R⁵
H₃ [symbol] —COO—R⁵ (11)
wherein, at least one of R⁵ represents A, and R⁵ other than A represents an alkyl group hating 1 to 20 carbon atoms. R⁵ may be mutually different. A represents the same meaning as described above.

Examples of the alkyl group having 1 to 20 carbon atoms include a methyl group, ethyl group, n-propyl group, iso-propyl group, n-butyl group, sec-butyl group, tert-butyl group, n-hexyl group, n-pentyl group, n-octyl group, nonyl group, decyl group, undecyl group, dodecyl group, tridecyl group, tetradodecyl group, pentadecyl group, hexadecyl group, heptadecyl group, octadecyl group, nonadecyl group, eicosyl group and the like.

When a substituent having as a bonding portion one of R⁵ contained in the formula (11) is represented by —B, the formula (12) is also included in the hindered amine-based compound of the present invention. 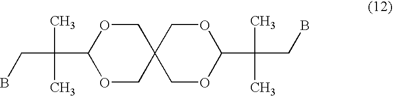
wherein, B may be mutually different.

Further, compounds having a molecular weight of 1000 to 4000 having the following repeating structural units can also be used as the hindered amine-based compound of the present invention. 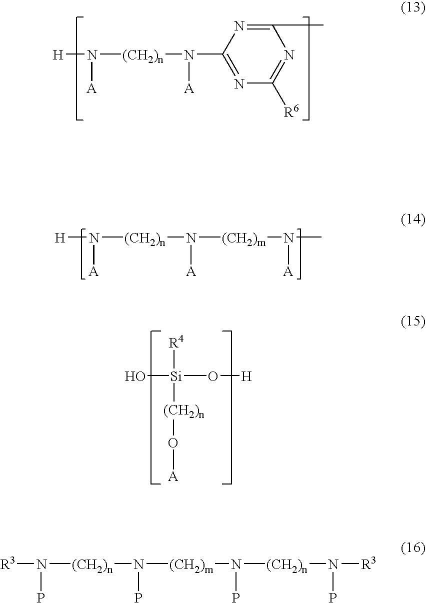
P: hydrogen atom or 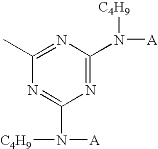
wherein, A, n, R³ and R⁴ represent the same meanings as described above, and m represents 2 to 20. R⁶ represents an amino group, alkylamino group having 1 to 20 carbon atoms, morpholino group, piperidino group or pyrrolidinyl group. P in the formula (16) contains at least one substituent containing A shown in (16) in the molecule.

Examples of the alkylamino group having 1 to 20 carbon atoms include a methylamino group, ethylamino group, N,N-dimethylamino group, N,N-diethylamino group, propylamino group, iso-propylamino group, butylamino group, sec-butylamino group, tert-butylamino group, hexylamino group, pentylamino group, octylamino group, nonylamino group, decylamino group, undecylamino group, dodecylamino group, tridecylamino group, tetradodecylamino group, pentadecylamino group, hexadecylamino group, heptadecylamino group, octadecylamino group, nonadecylamino group and the like.

Further, as the hindered amine-based compound containing no A, mentioned are compounds having a molecular weight of 1000 to 4000 having a repeating structural unit of the following formula (17) and compounds of the formula (18). 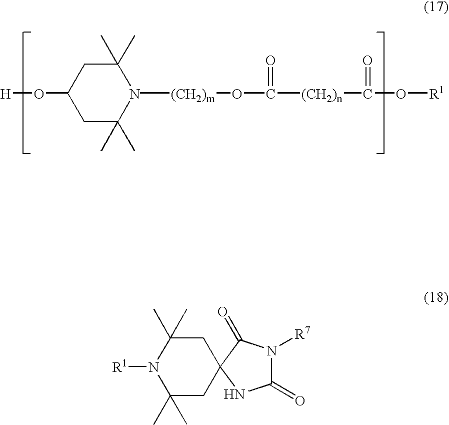
wherein, n, m and R¹ represent the same meanings as described above, and R⁷ represents a hydrogen atom or alkyl group having 1 to 20 carbon atoms.

Examples of the alkyl group having 1 to 20 carbon atoms include a methyl group, ethyl group, n-propyl group, iso-propyl group, n-butyl group, sec-butyl group, tert-butyl group, n-hexyl group, n-pentyl group, n-octyl group, nonyl group, decyl group, undecyl group, dodecyl group, tridecyl group, tetradodecyl group, pentadecyl group, hexadecyl group, heptadecyl group, octadecyl group, nonadecyl group, eicosyl group and the like.

Examples of commercially available products containing a hindered amine-based compound include Tinuvin 123 (in the formula (8), n represents 8 and R¹ in A represents —O—C₈H₁₇). Tinuvin 440 (in the formula (18), R¹ represents an acetyl group and R⁷ represents —C₁₂H₂₅), Tinuvin 770 (in the formula (8), n represents 8 and R¹ in A represents a hydrogen atom), Tinuvin 765 (in the formula (8), n represents 8 and R¹ in A represents a methyl group), Tinuvin 780 (in the formula (8), n represents 2 and R¹ in A represents a hydrogen atom), Tinuvin 905 (in the formula (16), all “P”s represent a substituent having A shown, R¹¹ in A represents a hydrogen atom, and R³ represents a methyl group), Chimassorb 119FL (the formula (16)), Chimassorb 944FL (in the formula (13), R¹ in A represents a hydrogen atom, R⁶ represents —NH—C₈H₁₇, n=6, particle form), Chimassorb 944LD (the same component as Chimassorb 944FL, powdery form), Lignostab 1198, Tinuvin 622LD (in the formula (17), n represents 2, m represents 2, R¹ represents a methyl group, molecular weight: 3,100 to 4,000) manufactured by Chiba Speciality Chemical, Adekastab LA-52 (in the formula (11), all of R⁵s represent A, and R¹ in A represents a methyl group), Adekastab LA-57 (in the formula (11), all of R⁵ represent A, and R¹ in A represents a hydrogen atom), Adekastab LA-62 (in the formula (11), R⁵ represents A or —C₁₃H₂₇, and R¹ in A represents a methyl group), Adekastab LA-63P (in the formula (12), R⁵ represents A, and R¹ in A represents a methyl group), Adekastab LA-67 (in the formula (11), R⁵ represents A or —C₁₃H₂₇, and R¹ in A represents a hydrogen atom), Adekastab LA-68LD (in the formula (12), R⁵ represents A, and R¹ in A represents a hydrogen atom) manufactured by Asahi Denka K.K., Cyasorb UV-3346 (in the formula (13), R¹ in A represents a hydrogen atom, and R⁶ represents a morpholino group, n=6), Cyasorb UV-3853S (in the formula (6), R¹ in A represents a hydrogen atom, and R² represents an alkyl group having 11 to 20 carbon atoms) manufactured by Sun-chemical K.K., Ubacil 299 (in the formula (15), n represents 3, R¹ in A represents a hydrogen atom) manufactured by Unichem K.K., Goodlight UV-3034 (in the formula (9), R¹ in A represents a hydrogen atom) manufactured by Goodrich, VP Sanduvor 3052 manufactured by Clariant, AFG-01 manufactured by Senka K.K., and the like, and these commercially available products may be used.

The adhesive may contain a dissolution aid for uniformly dispersing a hindered amine-based compound.

Examples of such a dissolution aid include ethylene glycol, diethylene glycol, triethylene glycol, ethy glycol, ethyl diglycol, ethyl triglycol, butyl glycol, butyl diglycol, propylene glycol, dipropylene glycol and the like.

The adhesive may contain acids for neutralizing a hindered amine-based compound. Such acids include hydrochloric acid, sulfuric acid, acetic acid, oxalic acid, phosphoric acid and the like.

The content of a hindered amine-based compound in the adhesive is usually from approximately 0.001 mg to 0.5 mg, preferably 0.005 mg to 0.1 mg, more preferably 0.01 to 0.05 mg, further preferably 0.01 mg to 0.02 mg, particularly preferably −01 mg to 0.015 mg, per 1 cm² of a polarizing plate. When the content is 0.001 mg or more, light resistance tends to be improved preferably, and when 0.5 mg or less, an adhesion effect tends to be excellent preferable.

According to the present invention, a polarizing plate showing further improved light resistance can be produced. Particularly, a polarizing plate obtained by using an adhesive containing a hindered amine-based compound is preferable since it can be easily obtained by using conventional polarizing film and protective films as they are.

Thus obtained polarizing plate can be used in plat panel displays (FPD) such as liquid crystal displays (LCD), organic electroluminesence (EL) and the like.

Specifically, a glass base material can be laminated on a polarizing plate via an adhesive to produce a liquid crystal display. Further, an organic electroluminesence (organic EL) display can be also be produced by forming at least one light emitting layer made of an electrically conductive organic compound between a transparent base plate carrying an electrode formed and an electrode made of gold, silver, aluminum, platinum and the like or alloy, to provide a polarizing plate of the present invention on the transparent base plate.

The polarizing plate of the present invention can be suitably used in flat panel displays (FPD) such as vehicle liquid crystal displays such as car navigations and the like, liquid crystal displays used in liquid crystal projectors, note type personal computer monitors, desk top monitors, liquid crystal televisions, cam coders, displays for amusement, portable information terminals, game machines, monitors for digital camera, portable telephones and the like, and organic EL apparatuses used in vehicle televisions, displays for car navigation, displays for portable telephone and the like, because of its excellent light resistance.

### EXAMPLES

The present invention will be illustrated further in detail based on examples, but it is needless to say that the present invention is not limited to the examples.

‘%’ and ‘parts’ in the examples are % by weight and parts by weight unless otherwise stated.

### Production Example 1

Production of Hindered Amine-Based Compound (1)

78 parts of 4-amino-2,2,6,6-tetramethylpiperidine was charged into a mixed solvent of 390 parts of ethyl acetate and 500 parts of methanol, and the mixture was stirred for 40° C. Separately, 53 parts of succinic anhydride, 263 parts of ethyl acetate and 500 parts of methanol were mixed, and dropped into the above-mentioned solution of a piperidine derivative over 1 hour. After dropping, the mixture was kept at 40° C. for 3 hours, then, cooled to lot, and thermally insulated for 3 hours, then, filtrated to obtain a wet cake. The wet cake was dried under reduced pressure, to obtain a hindered amine-based compound of the formula (1). The compound was dissolved in heavy water and ¹H NMR (270 MHz) thereof was measured to find δ 1.44 to 1-58 (14H), δ 2.06 (2H, dd), δ 2.45 (4H, s), δ 4.271 (1H, m).

### Production Example 2

Production of Hindered Amine-Based Compound (2)

78 parts of 4-amino-2,2,6,6-tetramethylpiperidine was charged into a mixed solvent of 390 parts of ethyl acetate and 300 parts of methanol, and the mixture was stirred for 40° C. Separately, 52 parts of maleic anhydride and 257 parts of ethyl acetate were mixed, and dropped into the above-mentioned solution of a piperidine derivative over 1 hour. After dropping, the mixture was kept at 40° C. for 3 hours, then, cooled to 10° C., and thermally insulated for 3 hours, then, filtrated to obtain a wet cake. The wet cake was dried under reduced pressure, to obtain a hindered amine-based compound of the formula (2). The compound was dissolved in heavy water and ¹H NMR (270 MHz) thereof was measured to find δ 1.45 to 1.59 (14H), δ 2.12 (2H, dd), δ 4.30 (1H, m), δ 5.94 (2H, d), δ 6.35 (2H, d).

### Example 1

A polyvinyl alcohol film [Kuraray Vinylon #7500, manufactured by Kuraray Co., Ltd.] having a thickness of 75 μm was 5-fold stretched along a longitudinal axis, to give a polarizing film base material. This polyvinyl alcohol film was dyed with a dye of the formula (19) while maintaining tensile condition, and a boric acid treatment was performed thereon to obtain a polarizing film.

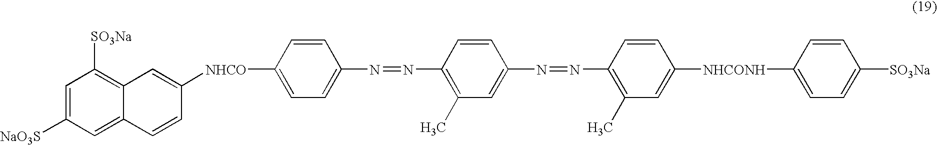

On the other hand, to a polyvinyl alcohol aqueous solution (molecular weight: 75,000) having an average polymerization degree of approximately 1,700 and a saponification degree of 99.6 mol % or more was added a hindered amine-based compound of the formula (1), to obtain an adhesive in the form of uniform solution in which the weight ratio of polyvinyl alcohol/hindered amine-based compound/water was 5/5/100. Using the adhesive, a triacetylcellulose-based film (“Konica TAC KC80UVSHF”, manufactured by Konica Corp.) having a thickness of 80 μm on which surface saponification treatment had been performed was adhered on both surfaces of the polarizing film, then, the polarizing film was dried at 50° C. for 10 minutes to obtain a polarizing plate. The thickness of the adhesive layer (one surface) of the resulted polarizing plate was approximately 0.1 μm, and the content (total of both surfaces) of the hindered amine-based compound (1) per 1 cm² of the polarizing plate was approximately 0.012 mg.

<Evaluation of Light Resistance>

Light from a 100 W high pressure mercury lamp was spectrally split by a dichroic filter to take light of wavelengths in the range from 420 nm to 500 nm, and the polarizing plate produced in Examples 1 was irradiated with this light. In this operation, the surface temperature of the polarizing plate was maintained at 120° C. The λmax absorbance along the absorption axis of the polarizing plate was measured before and after irradiation with light for 48 hours, and a difference ΔA was used as an index of light resistance. Lower ΔA indicates smaller light decomposition and thus higher light resistance. The results are shown in Table 1.

### Example 2

A polarizing plate was produced according to Example 1 except that a hindered amine-based compound of the formula (2) was used instead of the hindered amine-based compound of the formula (1) used in Example 1, and light resistance was measured in the same manner as in Example 1. A difference in absorbance (AA) before and after irradiation with light has a value as described in Table 1.

### Example 3

A polarizing plate was produced according to Example 1 except that AFG-01 manufactured by Senka K-K. was used instead of the hindered amine-based compound of the formula (1) used in Example 1, and light resistance was measured in the same manner as in Example 1. A difference in absorbance (ΔA) before and after irradiation with light has a value as described in Table 1.

### Comparative Example 1

A polarizing plate was produced according to Example 1 except that a hindered amine-based compound was not added, and light resistance was evaluated. A difference in absorbance before and after irradiation with light lowered to 0.8. The results are shown in Table 1.

TABLE 1

| | hindered amine-based compound | ΔA |
|---|---|---|
| Example 1 | formula (1) | 0.4 |
| Example 2 | formula (2) | 0.5 |
| Example 3 | AFG-01 | 0.3 |
| Comparative Example 1 | no hindered amine-based compound | 0.8 |

1. A polarizing plate comprising a dye and a hindered amine-based compound.

2. The polarizing plate according to claim 1, wherein the polarizing plate comprises a dye-based polarizing film and a protective film pasted via an adhesive for polarizing plate containing a hindered amine-based compound and at least one adhesive component selected from the group consisting of an adhesive component containing a polyvinyl alcohol having a molecular weight of 20,000 to 200,000 as an active ingredient, an adhesive component containing an acrylic resin as an active ingredient and an adhesive component containing a urethane resin as an active ingredient.

3. The polarizing plate according to claim 1, wherein the hindered amine-based compound is a compound having a 2,2,6,6-tetramethylpiperidine skeleton.

4. The polarizing plate according to claim 1, wherein the polarizing film is a film made of a polyvinyl alcohol-based resin.

5. A flat panel display comprising the polarizing plate according to claim 1.

6. An adhesive for polarizing plate comprising a hindered amine-based compound and at least one adhesive component selected from the group consisting of an adhesive component containing a polyvinyl alcohol having a molecular weight of 20,000 to 200,000 as an active ingredient, an adhesive component containing an acrylic resin as an active ingredient and an adhesive component containing a urethane resin as an active ingredient.
